(19) United States
(12) Patent Application Publication
(10) Pub. No.: US 2005/0159076 A1
(43) Pub. Date: Jul. 21, 2005

(54) Magnetic construction module with interchangeable magnet holders

(76) Inventors: Charles J. Kowalski, Ridgewood, NJ (US); Jeffrey H. Rosen, Aventura, FL (US); Lawrence I. Rosen, Mendham, NJ (US)

Correspondence Address: Ralph W. Selitto, Jr.;McCarter & English, LLP, Four Gateway Center, 100 Mulberry Street, Newark, NJ, 07102, US

(21) Appl. No.: 10/965,979

(22) Filed: Oct. 15, 2004

Related U.S. Application Data
(60) Provisional application No. 60/536,866, filed on Jan. 16, 2004.

(51) Int. Cl. G11B 5/41; A63H 33/26; G11B 5/10; G11B 5/127

(52) U.S. Cl. 446/137

(57) ABSTRACT

A magnetic construction module that is suitable for creating a variety of different construction profiles and lengths and that permits the construction of modules where at least some of the members are adapted to be flexible. A rod is attachable to a holder adapted for retaining a magnet. The magnet is retained in a pocket of the holder. The holder can be attached in rods of various lengths, curves, rigidities to conform to the shape desired by the user. An outer surface of the magnet is adapted to provide a magnetic connection to a magnetizeable element such as a metal sphere with which the rod and holder can be operatively associated for a particular construction profile. Moreover, the holder may also be securely, selectively connected to the rod via a male-female connection in order to provide greater construction flexibility.

### CROSS-REFERENCE TO RELATED PRIORITY APPLICATION

This patent application claims priority of U.S. Provisional Application Ser. No. 60/536,866, filed Jan. 16, 2004, and entitled “Magnetic Construction Modules For Creating Three-Dimensional Assemblies”, the disclosure of which is incorporated herein by reference in its entirety.

### FIELD OF THE INVENTION

The present disclosure is directed generally to puzzles and toys. More particularly, the present disclosure is directed to a construction toy for building stable two and three-dimensional structures utilizing magnet retaining elements, connecting elements, and magnetizable elements.

### BACKGROUND OF THE INVENTION

Individuals often find enjoyment in the challenge of building aesthetic structural designs and/or functional structural models. Frequently, the utility associated with constructing such structures is found in the creative and/or problem solving process required to achieve a desired structural objective. Currently, construction assemblies that exploit magnetic properties to interlink various structural components and thereby form different two and/or three dimensional structures are known and can provide an added dimension of sophistication to the construction process. Consider, for example, the magnetic construction toy disclosed by Balanchi in U.S. Pat. No. 6,626,727, the modular assemblies disclosed by Vicentielli in U.S. Pat. No. 6,566,992, and the magnetic puzzle/toy disclosed by Smith in U.S. Pat. No. 5,411,262.

A significant shortcoming associated with conventional magnetic construction assemblies, such as those disclosed in the aforementioned patents, involves inherently restrictive and at times penalizing design alternatives provided thereby. It is often the case that these traditional magnetic construction assemblies have only a limited number of component parts, which parts typically have constrained geometries to ensure effective and suitably stable or secure connections. Accordingly, despite efforts to date, a need remains for a magnetic construction module that provides greater construction flexibility and/or design choice. This shortcoming and other needs/objectives are satisfied by the present invention. Additional advantageous features and functionalities of the present invention will be apparent from the disclosure which follows, particularly when reviewed in conjunction with the accompanying drawings.

### SUMMARY OF THE INVENTION

In accordance with an illustrative embodiment of the present invention, a magnetic construction module is provided that permits improved structural profiles and increased construction flexibility and/or design choice. More particularly, the module of the present invention includes a holder that has at a first end a pocket adapted to retain a magnet, and a shank arranged at an opposite end. Advantageously, the holders can be attached/detached from rods of various lengths by simply plugging the shank into a recess of the desired rod. The magnet retained by the pocket has an exposed surface and is suitable to attach to another magnet or a metal element such as a spherical metal ball, or whatever shape/size may be desired. In addition, the pocket can be formed so as to have a beveled edge so as to cooperate with the exposed surface of the magnet to secure the holder to the metal ball both mechanically and magnetically.

The holder, in accordance with another advantageous aspect of the present invention, may be made of a ferromagnetic material to provide improved magnetic strength. Also, the rod, in accordance with yet another advantageous aspect of the present invention, may be a composite member to provide an increased degree of sophistication to the structural design/construction alternatives. Further, the rod, in accordance with a further advantageous aspect of the present invention, may be curved to provide further structural design/construction flexibility. Still further, in another advantageous aspect of the present invention, the rod may be flexible and/or any of a variety of lengths. For example, the rod can be bendable, and the first end and the second end of the rod are axially aligned at rest, whereas the first end and second end of the rod are axially unaligned when a sufficient force is applied transverse to a longitudinal direction of the rod to cause said member to bend. Other aspects and advantages will be readily apparent from the following detailed description of the exemplary embodiments.

### BRIEF DESCRIPTION OF THE DRAWINGS

For a better understanding of the present invention, reference is made to the following detailed description of various exemplary embodiments considered in conjunction with the accompanying drawings, in which:

FIG. 1 is an exploded perspective view of a module constructed in accordance with an exemplary embodiment of the present invention and including a rod and a pair of holders;

FIG. 2 is a schematic part-sectional side view of one of the holders illustrated in FIG. 1;

FIG. 3 is a schematic part-sectional side view of a modified version of the holder illustrated in FIG. 2;

FIG. 4 is a side elevational view of a modified version of the rod illustrated in FIG. 1;

FIG. 5 is a side elevational view of another modified version of the rod illustrated in FIG. 1;

FIG. 6 is a perspective view of an alternate embodiment of a rod constructed in accordance with the present invention;

FIG. 7 is a perspective view of another alternate embodiment of a rod constructed in accordance with the present invention;

FIG. 8 is a perspective view of yet another alternate embodiment of a rod constructed in accordance with the present invention;

FIGS. 9a and 9b are broken away views of two modified versions of the rod of FIG. 8.

FIG. 10 is a schematic illustration of one type of mechanical connection between a holder and a rod according to the present invention;

FIG. 11 is a schematic illustration of another type of mechanical connection between a holder and a rod according to the present invention; and

FIG. 12 is a schematic illustration of yet another type of mechanical connection between a holder and a rod according to the present invention.

### DESCRIPTION OF THE EXEMPLARY EMBODIMENTS

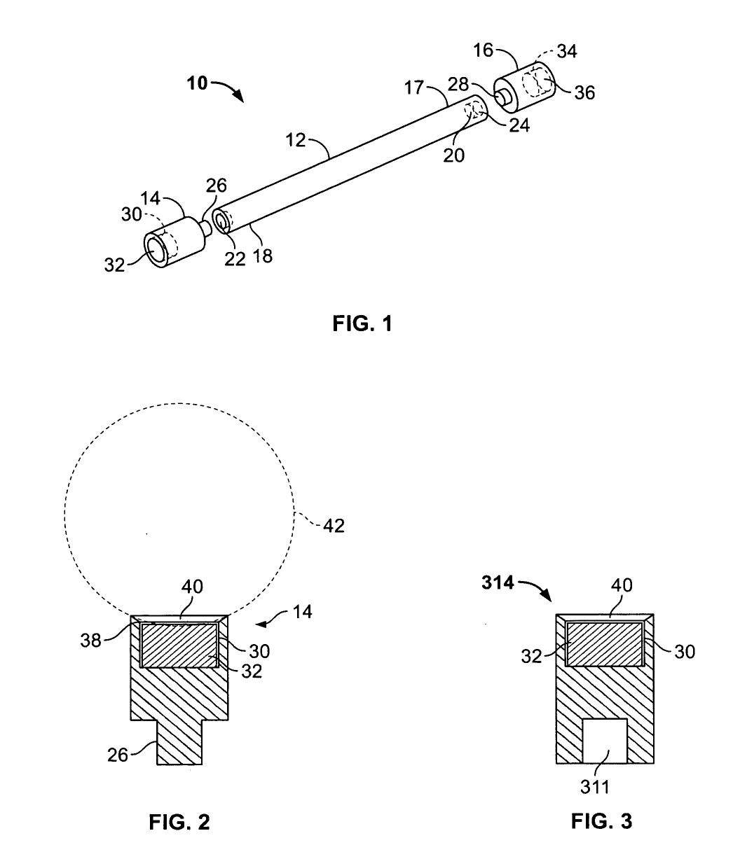

Referring to the drawings and, in particular, FIG. 1, a magnetic construction module 10 includes an elongated, cylindrical rod 12 and a pair of magnet holders 14, 16 attached to opposite ends 18, 20, respectively, of the rod 12. Each of the holders 14, 16 is adapted to be releasably connected to the substantially rigid rod 12 in a male-female connection, so that in a complementary fashion one element has a male member and the other element has a female member adapted to receive the male member. In the exemplary embodiment of the invention shown in FIG. 1, the rod 12 is provided with the female members in the form of recesses 22, 24 in the ends 18, 20, respectively, while the holders 14, 16 are provided with the male members in the form of shanks 26, 28, respectively. More particularly, the shanks 26, 28 are releasably received within the recesses 22, 24, respectively, of the rod 12, whereby a user has the ability to interchange the holders 14, 16 with each other and/or with similar or dissimilar holders.

The holder 14 has a pocket 30 at the end opposite the shank 26, the pocket 30 being sized and shaped so as to receive a magnet 32. Similarly, the holder 16 has a pocket 34 at the end opposite the shank 28, the pocket 34 being sized and shaped so as to receive a magnet 36. The pockets 30, 34 can be formed in a variety of sizes, shapes and/or configurations so long as they are adapted to retain the magnets 32, 36, respectively. For example, the pockets 30, 34 can be sized so as to frictionally retain the magnets 32, 36, respectively. Alternatively, the magnets 32, 36 could be bonded to the pockets 30, 34, respectively, with an adhesive. It should also be noted that while the pockets 30, 34 are especially adapted to retain the magnets 32, 36, the pockets 30,.34 may retain items other than magnets, such as Velcro, snap fasteners, etc.

With particular reference to FIG. 2, the pocket 30 is provided with a beveled edge 38, which projects beyond an exposed surface 40 of the magnet 32. The exposed surface 40, which may have any desired polarity (e.g., north or south), is adapted to establish a magnetic connection with either a magnet of another holder having an opposite polarity or with a spherical object 42, such as a metal ball, in which case the beveled edge 38 of the holder 14 adds a degree of mechanical support to the magnetic attraction between the spherical object 42 and the magnet 32.

Like the pocket 30 of the holder 14, the pocket 34 of the holder 16 is provided with a beveled edge (not shown) which projects beyond an exposed surface (not shown) of the magnet 36. Thus, like the magnet 32, the magnet 36 has an exposed magnetic surface that is recessed relative to the beveled edge of the holder 16. The exposed surface of the magnet 36 is adapted to establish a magnetic connection with either a magnet of another holder having an opposite polarity or with a spherical object similar to the spherical object 42.

One advantage of the present invention is that the pocket 30 of the holder 14 can retain the magnet 32 in a recessed manner so that while the exposed surface 40 of the magnet 32 provides a magnetic connection to the spherical object 42, the beveled edge 38 provides a mechanical connection to the spherical object 42. More particularly, the beveled edge 38 substantially conforms to the surface contour of the spherical object 42, which is effectively seated in the beveled edge 38. In addition, the beveled edge 38 can be roughened, or otherwise adapted, to increase the coefficient of friction thereof. Still further, the exposed surface 40 of the magnet 32 can have a curvature which conforms to the surface contour of the spherical object 42, thereby improving the overall magnetic connection therebetween. Accordingly, by utilizing both magnetic and mechanical connecting properties, the present invention provides greater connection stability and/or performance than known heretofore. It is noted that the spherical object 42 can be varied in size and need not be spherical, but can have any of a variety of other geometric shapes, sizes, or configurations suitable to effectively cooperate with the holder 14 and/or the magnet 32.

FIG. 3 depicts a holder 314 that is an alternate embodiment of the holder 14 shown in FIG. 1. Briefly stated, the embodiment of FIG. 3 operates in the same manner and provides the same advantages as the embodiment of FIG. 2, except that in lieu of a male member (i.e., the shank 26), the holder 314 has a recess 311 (i.e., a female member) that is adapted to receive a complementary male member provided on a rod (not shown).

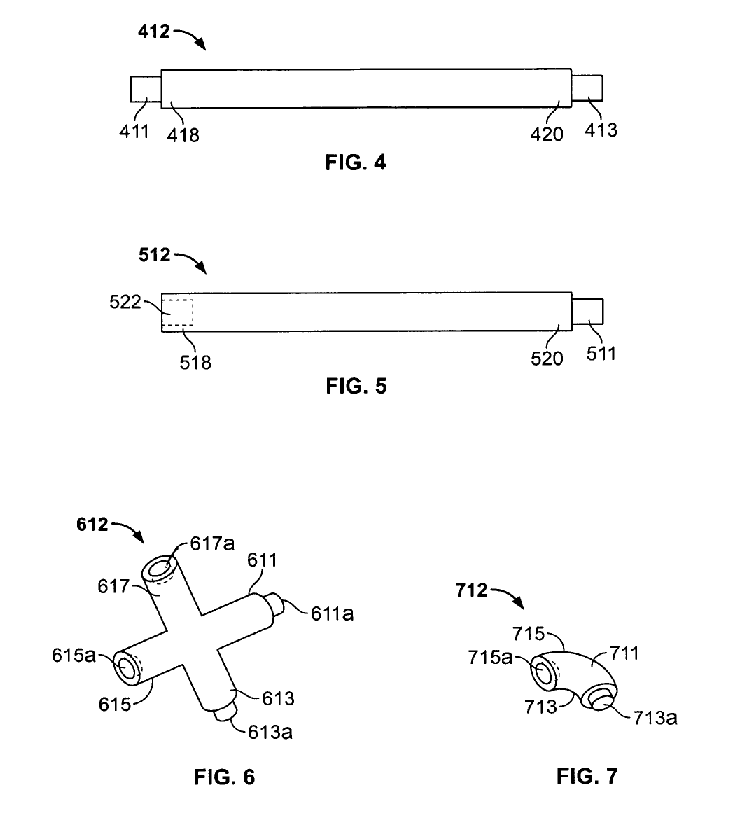

As will be readily apparent to those skilled in the pertinent art from the present disclosure, the rod 12 of FIG. 1 may have any of a variety of other configurations, so long as it is adapted to have a male-female mechanical connection with complementary holders. FIGS. 4-8, 9a and 9b illustrate of few of these possible configurations and are briefly discussed hereinbelow.

For example, FIG. 4 illustrates an exemplary embodiment of a rod 412 that can be used in conjunction with holders like the holder 314 shown in FIG. 3. Whereas the rod 12 shown in FIG. 1 had recesses 22, 24 arranged at opposite ends, rod 412 has shanks 411, 413 extending from opposite ends thereof. Each of the shanks 411, 413 is adapted to be releasably connected within a complementary female member, such as the recess 311 of the holder 314 shown in FIG. 3.

FIG. 5 illustrates yet another embodiment of a rod 512 that can be used in conjunction with holders such as the holder 14 shown in FIG. 1, and the holder 314 shown in FIG. 3. Whereas the rod 12 shown in FIG. 1 had recesses 22, 24 arranged at opposite ends, the 512 rod has an end 518 with a recess 522 therein, and another end 520 with a shank 511 extending therefrom. The recess 522 of the rod 512 is adapted to be releasably connected with a complementary male member of a holder, such as shank 26 of the holder 14 shown in FIG. 1. On the other hand, the shank 511 extending from the rod 512 is adapted to be releasably connected within a complementary female member, such as the recess 311 of the holder 314 shown in FIG. 3.

FIG. 6 illustrates an embodiment of a rod 612 that is formed in the shape of a cross, whereby the rod 612 has four ends 611, 613, 615 and 617. The ends 611, 613 of the cross-shaped rod 612 have respective shanks 611a, 613a, each of which extends from the rod 612 and is adapted to be releasably connected within a complementary female member, such as the recess 311 of the holder 314 shown in FIG. 3. Conversely, the ends 615,617 of the cross-shaped rod 612 have respective recesses 615a, 617a therein, each of which is adapted to be releasably connected with a complementary male member, such as the shank 26 of the holder 14 shown in FIG. 1.

FIG. 7 shows another variation regarding the structure of a curved rod 712, which is in the shape of an elbow having a predefined angle of curvature (e.g., 90 degrees). The curved rod 712 can be formed into elbows having angles less than or greater than 90 degrees according to need. In another aspect of the invention, (not shown), the length of the curved rod 712 could be adjustable by providing a hollow interior formed of at least two pieces having different diameters to permit a telescopic arrangement. The curved rod 712 has an end 713 with a shank 713a extending therefrom. The shank 713a is adapted to be releasably connected within a complementary female member, such as the recess 311 of the holder 314 shown in FIG. 3. Conversely, the curved rod 712 also has an end 715 with a recess 715a therein. The recess 715a is adapted to be releasably connected with a complementary male member of a holder, such as shank 26 of the holder 14 shown in FIG. 1.

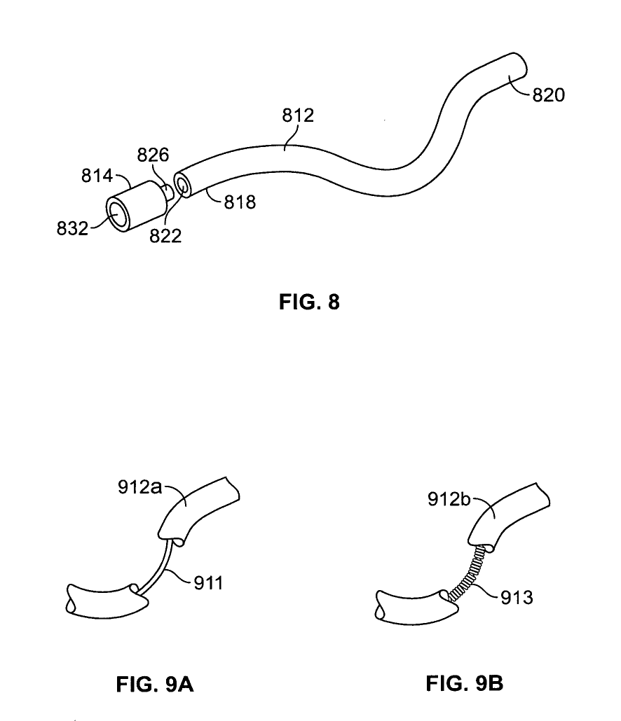

In a further exemplary embodiment of the present invention shown in FIG. 8, a rod 812, which has a pair of opposed ends 818 and 820, is formed from a bendable or flexible material made from a pliable, resilient material such as a soft metal, plastic or rubber material suitable to allow the rod 812 to be bent into any of a variety of curvilinear shapes. In this embodiment, a recess 822 is arranged in the end 818 of the rod 812 to releasably connect with a shank 826 of a holder 814 for a magnet 832. The end 820 may have a recess (not shown) or a shank (not shown), as desired.

FIG. 9a depicts yet another embodiment of the invention, wherein a rod 912a is shown having a pliable core 911, which can be made from any bendable material. FIG. 9b depicts a rod 912b, which is similar to the rod 912a except that the pliable core is in the form of a coil spring 913, which can be made from any material suitable for retaining the shape of the rod 912b, as desired.

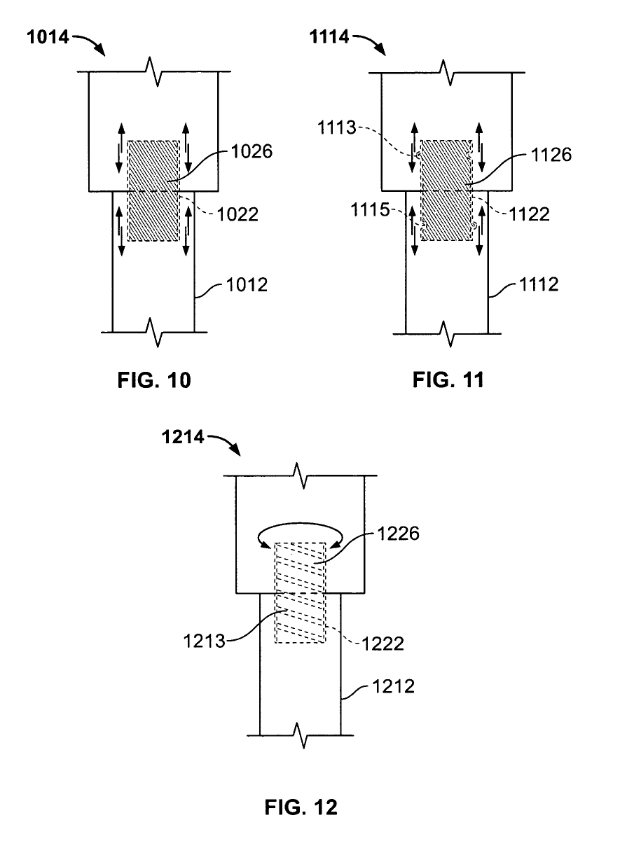

FIGS. 10-12 illustrate some of the variations regarding the releasable connection of the holder 14 to the rod 12. It is understood by an artisan that the variations in the type of releasable connection shown and described below can be applied to any of the different embodiments of complementary holders and rods previously shown and described.

FIG. 10 illustrates an example of a friction fit which is used to engage a shank 1026 of a holder 1014 (similar to the type shown in FIG. 1) within a recess 1022 of a rod 1012. The coefficient of friction associated with the outer surface of the shank 1026 and/or the inner surface of the recess 1022 may be adjusted by roughening as desired, via any known processes, of one or both of the mating surfaces. It is also understood and appreciated by an artisan that there is a variety of other mechanical connecting arrangements that can be used.

FIG. 11 is an illustration of a snap fit which is used to engage a shank 1126 of a holder 1114 (similar to the type shown in FIG. 1) within a recess 1122 of a rod 1112. In this embodiment, the shank 1126 has a boss 1113, while the recess 1122 has a complementary and corresponding groove 1115 to thereby prevent any inadvertent or unwanted release.

FIG. 12 is an illustration of the use of a threaded arrangement to engage a shank 1226 of a holder 1214 (similar to the type shown in FIG. 1) within a recess 1222 of rod 1212. In this embodiment, the shank 1226 has external threads 1213 that cooperate with complementary and corresponding internal threads (not shown) associated with the recess 1222. With this threaded arrangement, the holder 1214 and rod 1212 are connected by threading the shank 1226 into the recess 1222.

Although illustrative embodiments and exemplary aspects of the present disclosure have been described with reference to the schematic illustrations herein, the present disclosure is not limited thereto. Rather, the various structural components and/or assemblies disclosed herein, which have been provided for purposes of illustration and not for limitation, are susceptible to modification and/or variation without departing from the spirit of the present disclosure or the scope of the appended claims. Furthermore, it will be understood by those skilled in the pertinent art based on the teachings herein that the above-discussed structural components/features may be operatively connected to form a variety of different construction combinations, such as those disclosed in applicants' copending U.S. patent applications filed concurrently herewith and entitled “Magnetic Construction Modules For Creating Three-Dimensional Assemblies” and “Magnetic Construction Kit With Wheel-Like Components,” respectively, the disclosures of which are incorporated herein by reference in their entireties.

1. A magnetic construction module, comprising a rod having at least one end provided with a first connector; and a holder removably attached to said rod in an end-to-end relationship, said holder having a magnet mounted in one end thereof and a second connector located at an opposite end thereof and adapted to releasably engage said first connector.

2. A magnetic construction module according to claim 1, wherein a male-female type of engagement exists between said first and second connectors.

3. A magnetic construction module according to claim 2, wherein said first connector is a male member and said second connector is a female connector.

4. A magnetic construction module according to claim 2, wherein said first connector is a female member and said second connector is a male member.

5. A magnetic construction module according to claim 2, wherein said at least one end of said rod is directly attached to said opposite end of said holder.

6. A magnetic construction module according to claim 5, wherein said one end of said holder includes a pocket sized and shaped so as to receive said magnet.

7. A magnetic construction module according to claim 6, wherein said magnet is recessed relative to said one end of said holder.

8. A magnetic construction module according to claim 7, wherein said pocket has a beveled edge adjacent to said one end of said holder, said magnet being recessed relative to said beveled edge.

9. A magnetic construction module according to claim 2, wherein a friction fit exists between said first and second connectors.

10. A magnetic construction module according to claim 2, wherein a snap fit exists between said first and second connectors.

11. A magnetic construction module according to claim 2, wherein a threaded connection exists between said first and second connectors.

12. A magnetic construction module according to claim 1, wherein said rod is rigid.

13. A magnetic construction module according to claim 12, wherein said rod has a straight elongated shape.

14. A magnetic construction module according to claim 12, wherein said rod is in the shape of an elbow.

15. A magnetic construction module according to claim 12, wherein said rod is in the shape of a cross.

16. A magnetic construction module according to claim 1, wherein said rod is flexible.

17. A magnetic construction module according to claim 1, wherein said rod is bendable into various curvilinear shapes.

18. A magnetic construction module according to claim 17, wherein said rod includes a core adapted to maintain the shape of said rod after it has been bent into a desired curvilinear shape.

19. A magnetic construction module, comprising a rod having a first end provided with a first connector and a second end provided with a second connector; a first holder removably attached to said rod in an end-to-end relationship, said first holder having a first magnet mounted in one end thereof and a third connector located at an opposite end thereof for releasable engagement with said first connector; and a second holder removably attached to said rod in an end-to-end relationship, said second holder having a second magnet mounted in one end thereof and a fourth connector located at an opposite end thereof for releasable engagement with said second connector.

20. A magnetic construction module according to claim 19, wherein said first and second connectors are interchangeable with each other.
